(19) United States
(12) Patent Application Publication
(10) Pub. No.: US 2007/0047386 A1
(43) Pub. Date: Mar. 1, 2007

(54) Fresh fruit juice blender

(76) Inventor: Sam Nia, Cumming, GA (US)

Correspondence Address: R & G CONSULTANTS LLC, 1927 PIERCE WAY, BUFORD, GA, 30519, US

(21) Appl. No.: 11/214,154

(22) Filed: Aug. 30, 2005

(51) Int. Cl. B01F 11/00

(52) U.S. Cl. 366/255

(57) ABSTRACT

The Fresh Fruit Juice Blender is the only juice blender that mixes the fruit with the water manually without electrical current. The pieces of fruit are cut up and placed in the bottom of the blender. The internal are then placed in the blender and by manually moving the internal chopper up and down the fruit pieces are chopped up into a fruit mulch therefore blending with the water creating a fruit drink. The amount of chopping and blending will determine the strength of the drink. This is the only Manual Juice Blender that has a manual up and down manual chopper attached as part of the internal mechanism for creating a fruit drink. The blades attached to the manual shaft create the pulp and juice during the up and down movement from the cut up fruit pieces, allowing them to agitate upwards to the water. This blending with the water creates the fruit drink.

### PURPOSE

The purpose of the Fresh Fruit Juice Blender is to have the only product on the market where an individual can take any fruit and cut them up, place them in the bottom of a container, add your favorite beverage (water, wine, fruit juice), add a sweetener if desired, and mix them to satisfy their taste buds. In this process, an individual can mix unlimited flavors with it, or sweeten the drink with their own type of sweetener. The purpose is also to have a Fresh Fruit Juice Blender that does not require any electrical hook up, enabling the unit to be transported anywhere, anytime. For example: it can be taken on a picnic, to a sporting event, or just for traveling in the car. This process of mixing your own fruits with your favorite beverage and desired sweetener gives an individual the advantage of mixing the drink at their convenience so they will always have a fruit drink that is fresh.

Not only is the purpose of the Fresh Fruit Juice Blender to have a fresh fruit drink, but also to have a Fresh Fruit Juice Blender that can be disassembled easily, without the necessity for a lot of fasteners (screws, nuts, bolts, etc.), with a minimum amount of storage, and can be put in the dishwasher without worrying about where to store the fasteners or miscellaneous parts until the unit is washed. This is simply done by sliding the mixing unit out of the mixing container and placing it in the dishwasher. Since the Fresh Fruit Blender does not have any electrical wiring or electrical components, there is no worry about washing or damaging electrical components.

### OPERATING THE FRESH FRUIT JUICE BLENDER

To operate the Fresh Fruit Juice Blender, the internal parts of the Drink Blender have to be removed. This is done by taking hold of the knurl knob (FIG. 1, Item 1) and pulling outward away from the bottom of the Drink Blender (FIG. 1, Item 2). After the internal parts (FIG. 2) of the Drink Blender have been removed from the Fresh Fruit Juice Blender body (FIG. 3, Item 4), the Drink Blender is now ready to have the cut-up fruits placed in the empty container. In placing the cut-up fruits in the container, it is important that the fruits do not go above the fill line indicated on the inside of the container (FIG. 3, Item 5). It is important that the individual does not put in the container any peelings, which would cause the blades in the Fresh Fruit Juice Blender to not function. The Fresh Fruit Juice Blender is intended to operate with oranges, strawberries, blueberries, or any other fruit that can be blended and cut up to create a juice. After the cut-up fruit pieces have been placed in the bottom of the container (FIG. 3, Item 4), the Juice Blender internals (FIG. 2) can now be placed back inside the container. The Fresh Fruit Juice Blender will now appear to as shown in (FIG. 1). It is important that the top part of the internals appear in place as shown in (FIG. 1, Item 6). This helps eliminate any splash out while operating the Juice Blender.

To create the juice, the individual now rotates the internals by rotating the Knurl Knob (FIG. 1, Item 1) in a clockwise direction. At the same time, the individual is rotating the blades (FIG. 1, Item 7), he is also pushing the blades up and down, cutting into the fruits as shown in (FIG. 1, Item 8). This process of rotating and moving the Internals up and down and cutting into the fruits creates a looseness of the fruits, thereby creating a pulp mixture.

At this time, water is poured into the container through the top holes of the internals (FIG. 5, Item 9). The water is poured into the container to the Water Level Mark (FIGS. 1, 3, and 4, Item 10). Then the Knurl Knob (FIG. 1, Item 1) is rotated and moved up and down to mix the fruit pulp with the water. When the individual is pleased with the proper mixture by sampling the drink, he can then grasp the handle (FIG. 1, Item 11) and pour the blended Juice drink from the container through the spout (FIG. 1, Item 12).

### DESCRIPTIONS OF THE FIGURES

FIG. 1: Shows the Fresh Fruit Juice Blender with the side cut away to view the complete assemble of the Blender. This figure is showing the Blender with the blades in the raised position before the cut fruits are placed in the Blender.

FIG. 2: Shows the Internal workings of the Juice Blender as it is taken out of the container. This view is also to assist in understanding that the Internal working pulls out as a unit or one piece construction.

FIG. 3: This view is to show the container with the Internal working taken out to demonstrate and show the limit lines of where to fill the cut fruits and the water.

FIG. 4: Shows the top view of the Fresh Fruit Juice Blender with the top plate in view to demonstrate the opening to pour the water in.

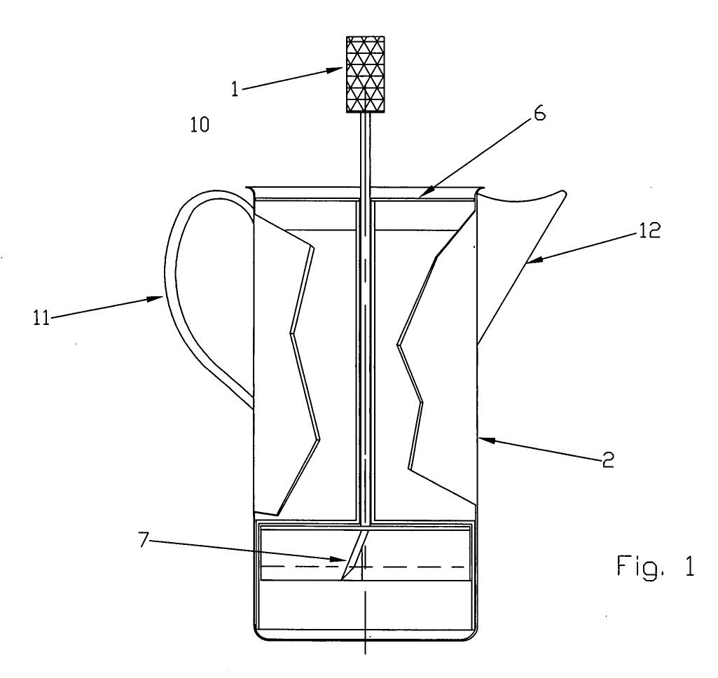

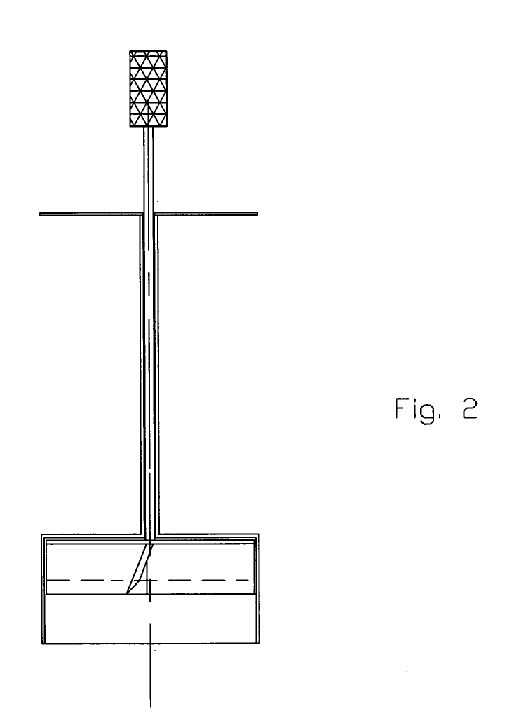

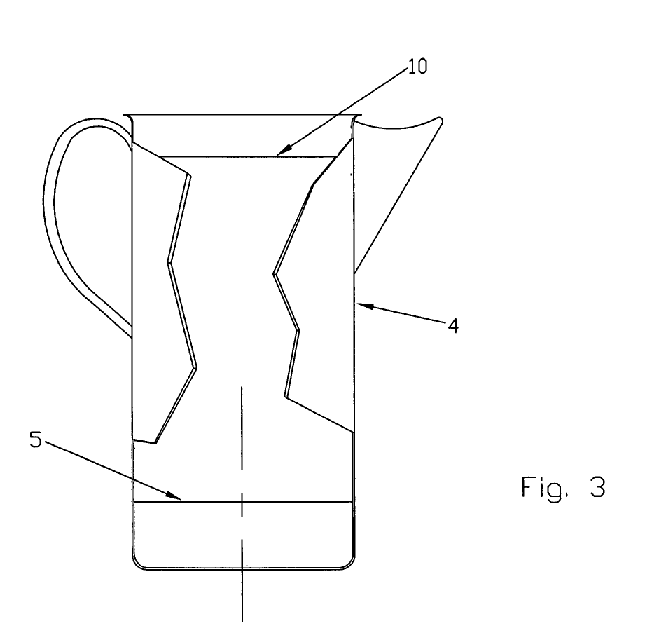

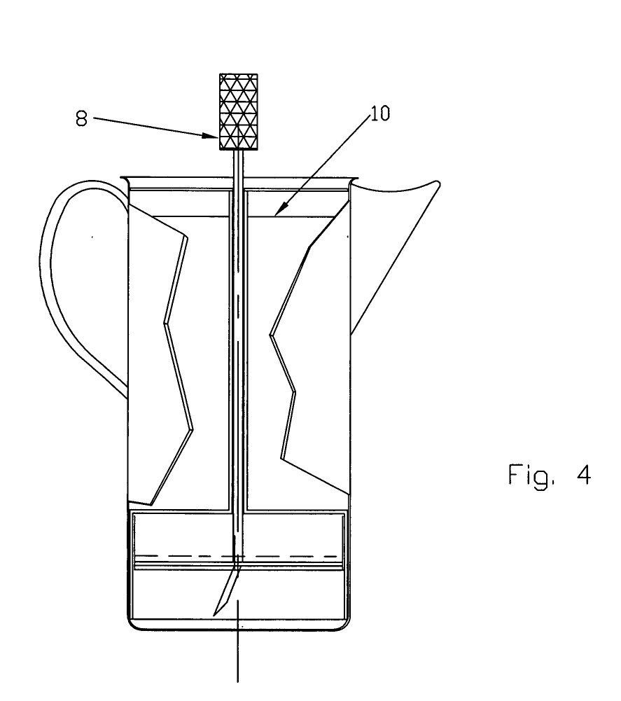

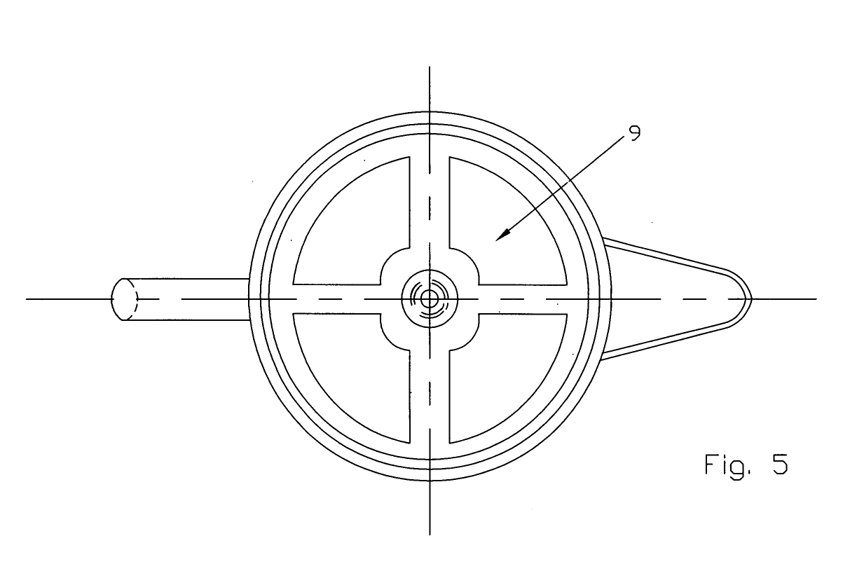

I claim

1. I claim the Fresh Fruit Juice Blender is the only Juice Blender that does not require electrical current and is fully mechanical to mix the fruit and create the fruit drink.

2. I claim the only Fresh Fruit Juice Blender that the individual can put any type of fruits into the blender and create a juice drink of their choice; such as orange and apple, orange and grapefruit, peach, apple and orange, etc.

3. I claim the only Fresh Fruit Juice Blender that has spiral blades that turn the fruits pieces and cut them up creating a pulp for the water to create the juice drink by allowing the individual to move the spiral blades up and down to create the juice drink.
